(19) United States
(12) Patent Application Publication
(10) Pub. No.: US 2002/0145058 A1
(43) Pub. Date: Oct. 10, 2002

(54) Razor cleaning apparatus

(76) Inventor: George Tziviskos, Encino, CA (US)

Correspondence Address: GEORGE TZIVISKOS, 5470 FORBES AVENUE, ENCINO, CA, 91436, US

(21) Appl. No.: 09/778,620

(22) Filed: Feb. 8, 2001

(51) Int. Cl. B05B 7/30

(52) U.S. Cl. 239/320; 239/349; 239/354

(57) ABSTRACT

A device for cleaning razors uses a variety of pressurizing means to force water or other cleaning fluid contained in an external container or in a chamber within the device, through a maneuverable nozzle. The maneuverability of the nozzle allows the user to direct the jet of water or other cleaning fluid to areas of the razor that are filled with lather and hair particles, and quickly and efficiently clean the razor. Means for controlling the water flow may be included and preferably located near the nozzle.

### BACKGROUND OF THE INVENTION

The present invention relates to devices used for cleaning shaving razors, and more particularly to a portable device that produces a flow of cleaning fluid, which can be directed at hair particles and shaving cream trapped in a razor, thereby dislodging and washing such debris away from the razor.

Trapped hair particles in a razor reduce its cutting effectiveness, and are a source of skin irritation during shaving. Therefore, constant cleaning of the razor during shaving is required to maintain an acceptable performance. The most common method of cleaning is by placing the razor under running water and, often, imparting mechanical shock by “tapping” the razor against the sink surface. This method is very ineffective and time-consuming, especially with the double- and triple-blade razors, and the newer, thicker shaving creams. These creams, mixed with the hair particles, are extremely difficult to remove from the crevices between the blades. “Tapping” also creates mechanical stresses that are damaging to the razor.

Clearly, a need exists for a fast, effective and low-mechanical-stress method to clean razors. There is a number of patents describing devices that attempt to address the issue. U.S Pat. No. 4,027,387 (Kellis), U.S Pat. No. 4,480,387 (d'Alayer de Costemore d'Arc), U.S Pat. No. 4,838,949 (Dugrot) and U.S Pat. No. 4,941,492 (Morgan) all describe devices that have a chamber which receives the razor head and means that attach to a water faucet, which provides water under pressure for cleaning the razor. The usefulness of such devices is limited, as they cannot be used with all available faucet designs. Furthermore, as the water flow needs to be aimed accurately at the areas of hair particle and soap accumulation, positioning the razor head within the cavity that receives it, is critical. “Blindly” placing the razor head within the cavity will not result in an effective cleaning. Additionally, with the proliferation of razor head shapes and sizes in the market, proper fit between the chamber and the razor head is not always possible.

U.S Pat. No. 5,365,958 (Stuhlmacher) describes a device which allows the razor to be moved relative to the water jets, therefore addressing one of the disadvantages of the earlier inventions. However, this device requires permanent attachment to the water supply for operation, hampering its portability.

All the patents discussed so far need to be attached to the water supply during operation, which limits their flexibility and requires them to use water as the only cleaning fluid.

U.S Pat. No. 6,009,622 (Liedblad) describes a device having a recess for the razor, which is submerged in water together with the razor and water pressure is generated by squeezing the device. This system requires the application of manual power in real time for its operation, so results will vary from person to person. While this device eliminates the need for connection to the faucet, and is capable of using cleaning fluids other than water, it still has the disadvantage of most of the previously discussed devices in that the placement of the razor head relative to the water flow is fixed resulting, as explained earlier, in diminished cleaning effectiveness. This device will also be slippery, and therefore difficult to operate, when covered with shaving cream and water.

A simple approach to cleaning razors would be to use a syringe with a nozzle attached to one end and a piston-plunger combination that is able to move freely within it. After initially filling the syringe with water, pushing the plunger would force water to be expelled through the nozzle. The water jet thus created could be used to clean a razor. A disadvantage of this approach is that it is difficult to accurately aim the nozzle while concurrently pushing the plunger on the opposite end of the syringe.

The advantages of a moveable and aimable nozzle are clear in mouth irrigation systems. There exist in the market several such systems capable of producing a high pressure, aimable water jet that could be used to clean razors. The disadvantage of such devices is that they all require AC power, and they are fairly large in size, both of which reduce their portability and their usefulness as razor cleaning systems.

The need, therefore, exists for a portable, self-contained razor cleaning system, capable of using water and/or a variety of other cleaning fluids, that allows the user to direct a stream of said cleaning fluids to areas of shaving residue accumulation in the razor for high cleaning effectiveness.

### BRIEF SUMMARY OF THE INVENTION

The present invention addresses the above and other needs, by providing a method of generating pressure independent of the user's physical ability and independent of faucet design, using relatively small amounts of water or other cleaning fluids. Furthermore, this invention describes a razor cleaning device able to produce at least one maneuverable stream of cleaning fluid that can advantageously be directed at areas of shaving residue accumulation in a razor, for cleaning the razor.

One important advantage of this invention is that it allows manipulation of the stream of cleaning fluid, in moving this stream across the razor and altering its angle of incidence, which further enhance the ability of this invention to clean the razor, as these actions create pressure waves that dislodge all shaving residue. Another advantage of this invention is the use of turbulent flow to enhance its cleaning ability.

A further advantage of this invention is that it is capable of cleaning any razor, cartridge or blade of any size, of the single- or multi-blade configuration, and whether the razor cartridge or blade is attached to the body of the razor or has been removed therefrom. The usefulness of the device is not limited to cleaning razor blades only, but this invention is also capable of cleaning the entire body of the razor, or other items, from accumulated debris over a period of use.

In the following, we shall refer to water and the cleaning fluid interchangeably, with the understanding that this invention is capable of using a variety of cleaning fluids, even including compressed gases, instead of, or in addition to, water.

In a preferred embodiment of this invention a set of batteries supply power to an electric motor driving a pump. Water is stored in a compartment within the device, and is forced by the pump through an opening in the wall of the device. This opening, by manipulation of the device, can easily and advantageously be directed at the specific locations of hair and lather accumulation in the razor. The battery-motor combination allows the device to be extremely small in size and self-sufficient in regards to energy needs. The water holding compartment and the small size of the device increase its portability. The pressure that the motor generates can advantageously and controllably produce a high velocity stream of water, with high cleaning effectiveness, such that smaller amounts of water and shorter times are necessary to thoroughly clean a razor.

In a second embodiment of this invention a set of batteries supply current to an electric motor driving a pump, which is immersed in water. The pump is forcing water through flexible tubing having one open end. This open end can easily and advantageously be directed at the specific locations of hair and lather accumulation in the razor. The battery-motor combination allows the device to be extremely small in size, and self-sufficient in regards to energy needs. The small size of the device permits its placement in an open container as small as a drinking cup. The pressure that the motor generates can advantageously and controllably produce a high velocity stream of water, with high cleaning effectiveness, such that smaller amounts of water and shorter times are necessary to thoroughly clean a razor.

In a third embodiment of the invention a spring located within the proximal end of a water chamber is driving a piston that moves within said water chamber. On the distal end of the water chamber a nozzle, or flexible tubing terminating in a nozzle, is attached. In operation the user preloads the spring by pulling onto a plunger connected to the piston. This action also may be used to fill the water chamber with water through the nozzle. Once the spring is preloaded, it can be controllably released via a mechanical trigger that acts directly onto the plunger, or via a valve advantageously located near the nozzle or at the distal end of the water chamber. This design combines the operation of preloading and filling the device with water in one step. Operating costs of this embodiment are minimal.

A variety of other embodiments are within the scope of the present invention. By way of example such an embodiment may comprise a miniature compressed gas cylinder which is attached to the main body of the device via a quick disconnect valve, and forces water contained in a chamber within the device, through a nozzle. The nozzle may be attached to the main body of the invention either directly or through flexible tubing. Means for controlling the pressure and flow of the water may advantageously be located near the nozzle and, optionally, between the compressed gas cylinder and the water chamber.

In yet another embodiment of the invention a manual pump and pressure chamber may replace the compressed gas cylinder. The user at first uses the pump to drive and pressurize air into the pressure chamber. Then operation continues as in the previous embodiment. This design eliminates the dependency on the availability of a compressed gas cylinder, and has lower operating costs.

These embodiments of the invention describe a miniature, flexible, self-contained, and very portable system, with improved cleaning and water usage efficiency over systems described in the prior art. All these embodiments can operate independently of faucet design and employ a maneuverable nozzle, which advantageously permits directing the water jet to the specific locations of the razor with hair and lather accumulation. The designs describe a single nozzle, but a multiple-nozzle design is also within the scope of this invention.

Although the invention has been presented herein in terms of specific embodiments, a person skilled in the art will realize that several other variations are possible and are within the scope of the present invention.

### BRIEF DESCRIPTION OF THE DRAWINGS

The above and other features and advantages of the present invention will be more apparent from the following more particular description thereof, presented in conjunction with the following drawings, wherein:

FIG. 1 is a cross-sectional view of a self-contained, motor-driven razor cleaner;

FIG. 2 is a cross-sectional view of an immersion-type, motor-driven razor cleaner having a flexible output tube;

FIG. 3 is an isometric view of an immersion-type, motor-driven razor cleaner;

FIG. 4 is a cross-sectional view of a tabletop, AC motor-driven razor cleaner, having flexible intake and output tubes;

FIG. 4A is a cross-sectional view of a motor-driven razor cleaner, wherein the free end of the intake tube has a weight attached;

FIG. 4B depicts a clip and ring system for attaching an intake tube to a cleaning fluid container.

FIG. 5 is a cross-sectional view of a manually-operated razor cleaner;

FIG. 6 is a detail cross-sectional view of a nozzle;

FIG. 6A is a detail cross-sectional view of a nozzle, having turbulence-generating internal wall features;

FIG. 6B is a detail cross-sectional view of a nozzle, having splash guards;

FIG. 7 is an isometric view of an AC operated, tabletop, motor-driven razor cleaner, having conditioning electronics, a collapsible chamber for holding cleaning fluid, and a multi-output nozzle design;

FIG. 8 is an isometric view of a charging station, and a motor-driven razor cleaner having rechargeable batteries;

FIG. 9 is a cross-sectional view of a manually-operated razor cleaner, having a brake for controlling the flow of cleaning fluid;

FIG. 10 is a cross-sectional view of a nozzle having a flow control valve.

For the convenience of the reader, below is a list of reference numbers associated with the figures.

| Ref. Number | Component |
|---|---|
| 10 | Housing |
| 15 | Clearance Bump |
| 20 | Motor |
| 25 | Motor Shaft |
| 30 | Holding Chamber |
| 35 | Cleaning Fluid Container |
| 36 | Cleaning Fluid |
| 40 | Battery |
| 45 | Pump Cavity |
| 50 | Impeller |
| 60 | Pump Intake Port |
| 70 | Pump Output Port |
| 75 | Nozzle |
| 76 | Nozzle Input Aperture |
| 77 | Nozzle Output Aperture |
| 78 | Roughened Interior Wall of Output Aperture |
| 79 | Splash Guard |
| 80 | Pump Seal |
| 90 | Intake Channel |
| 100 | Switch |
| 110 | Switch Cover |
| 120 | Negative Wire |
| 121 | Neutral Wire |
| 125 | Positive Wire |
| 126 | Hot Wire |
| 130 | Battery Chamber Cover |
| 140 | Negative Contact |
| 150 | Vent |
| 160 | Holding Chamber Cover |
| 170 | Vent Valve |
| 180 | Battery Chamber |
| 190 | Positive Contact |
| 200 | Flexible Output Tube |
| 210 | Free End of Flexible Output Tube |
| 220 | Attached End of Flexible Output Tube |
| 230 | Flexible Intake Tube |
| 240 | Free End of Flexible Intake Tube |
| 245 | Weight |
| 247 | Clip |
| 248 | Ring |
| 250 | Attached End of Flexible Intake Tube |
| 260 | Plunger |
| 270 | Piston |
| 280 | Spring |
| 290 | Electric Cable |
| 300 | Electric Plug |
| 310 | Charging Base |
| 320 | Conditioning Electronics |
| 350 | Valve Actuator |
| 360 | Actuator Port |
| 370 | Actuator Spring |
| 380 | Valve Input Aperture |
| 390 | Valve Output Aperture |
| 400 | Brake Mechanism |
| 410 | Brake Handle |
| 420 | Brake Plate |
| 430 | Brake Spring |
| 440 | Pivot Pin |
| 450 | Brake Support Structure |
| 460 | Brake Plate Opening |

### DETAILED DESCRIPTION OF THE INVENTION

The following description is of the best modes presently contemplated for carrying out the invention. This description is not to be taken in a limiting sense, but is made merely for the purpose of describing the general principles of the invention. The scope of the invention should be determined with reference to the claims.

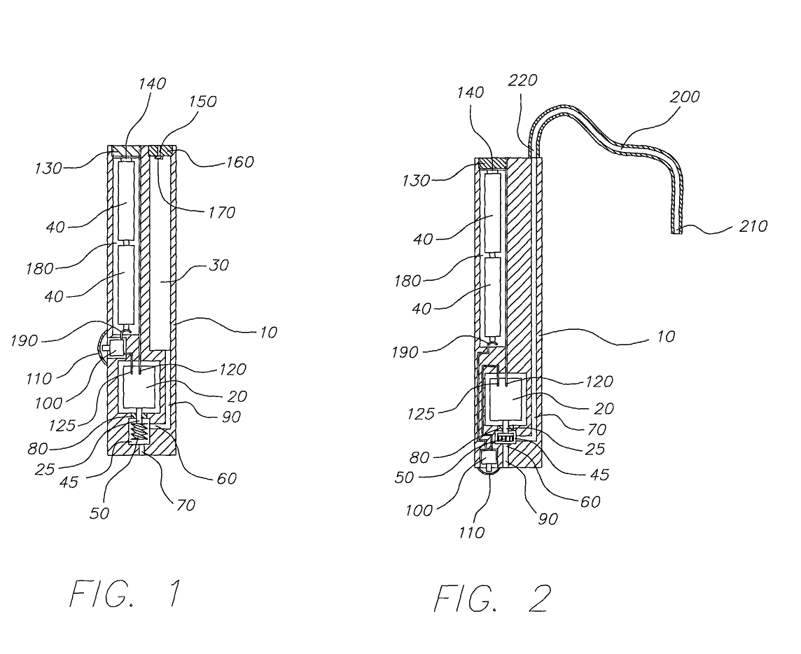

FIG. 1 depicts a cross section of a preferred embodiment of this invention, comprising a Housing 10, having a Holding Chamber 30, for holding cleaning fluid. The Holding Chamber 30, has a Holding Chamber Cover 160, having a Vent 150, and a Vent Valve 170, and is fluidly communicating with a Pump Intake Port 60, via an Intake Channel 90. The Pump Intake Port 60, leads to a Pump Cavity 45, which houses an Impeller 50. The Pump Cavity 45, also has a Pump Output Port 70, which forms the output of the system.

The Impeller 50, is mechanically connected to a Motor 20, via a Motor Shaft 25. A Pump Seal 80, around said Motor Shaft 25, separates the Pump Cavity 45, from said Motor 20, and prevents cleaning fluid from flowing towards the Motor 20.

Said Motor 20, is electrically connected to Batteries 40, residing in a Battery Chamber 180, within said Housing 10, via a Positive Contact 190, a Switch 100, a Positive Wire 125, a Negative Wire 120, and a Negative Contact 140, such that the Switch 100, controls the flow of electrical current through the Motor 20. Said Negative Contact 140, is attached to a Battery Chamber Cover 130, said Battery Chamber Cover 130, forcing the Batteries 40, against themselves and the Negative Contact 140, and the Positive Contact 190, thereby maintaining good electrical connection between said components.

A flexible Switch Cover 110, preferably made by an elastomeric material, is attached to the Housing 10, and environmentally protects the Switch 100.

The Switch 100, is preferably a push-on momentary switch, but other types of switches, including toggle types may be used.

Wherein, in operation, a user first fills the Holding Chamber 30, with cleaning fluid, and then closes the Holding Chamber 30, using the Holding Chamber Cover 160. Then the user operates the Switch 100, by depressing the Switch Cover 110, thus activating the Motor 20. The Motor 20, pumps cleaning fluid from the Holding Chamber 30, and expels it through the Pump Output Port 70. The user, by manipulating the entire device, may then direct the stream of cleaning fluid thus generated, at locations of shaving residue accumulation in the razor, cleaning said razor. The Holding Chamber Cover 160, prevents cleaning fluid from flowing outside the Holding Chamber 30, while the device is manipulated by the user. The Vent Valve 170, is preferably a thin elastomeric leaf, such as one made of silicone rubber, of generally rectangular shape, having three free sides and having a fourth side attached to the inside surface of the Holding Chamber Cover 160, extending over the opening of the Vent 150. The Vent Valve 170, is thus able to maintain atmospheric pressure within the Holding Chamber 30, by allowing air to enter, while keeping cleaning fluid from flowing out of the Holding Chamber 30. Other valve designs, commonly known as check valves, essentially accomplishing the same task, may be used in lieu of the aforementioned valve design.

FIG. 2 depicts a different embodiment of the invention, of the immersion type, wherein the invention comprises a Housing 10, having a Motor 20, mechanically connected to an Impeller 50, residing in a Pump Cavity 45, via a Motor Shaft 25. A Pump Seal 80, around the Motor Shaft 25, keeps fluids from entering the Motor 20.

The Pump Cavity 45, has a Pump Intake Port 60, connected to the outside via an Intake Channel 90, and a Pump Output Port 70, fluidly communicating with a Flexible Output Tube 200, having an Attached End 220, attached to the Housing 10, and a Free End 210, open to the outside.

The motor is electrically connected to Batteries 40, residing in a Battery Chamber 180, via a Positive Wire 125, a Switch 100, a Positive Contact 190, a Negative Contact 140, and a Negative Wire 120, such that the Switch 100, controls the flow of electrical current through the Motor 20. Said Negative Contact 140, is attached to a Battery Chamber Cover 130, said Battery Chamber Cover 130, forcing the Batteries 40, against themselves and the Negative Contact 140, and the Positive Contact 190, thereby maintaining good electrical connection between said components.

The Switch 100, is advantageously located in the bottom of the Housing 10, and operated by the weight of said Housing 10. The Switch 100, is preferably a push-on momentary switch, but other types of switches, including toggle types may be used.

Said Battery Chamber Cover 130, environmentally protects the Battery Chamber 180, preventing liquids from entering the Battery Chamber 180, whereas a flexible Switch Cover 110, attached to the Housing 10, environmentally protects the Switch 100.

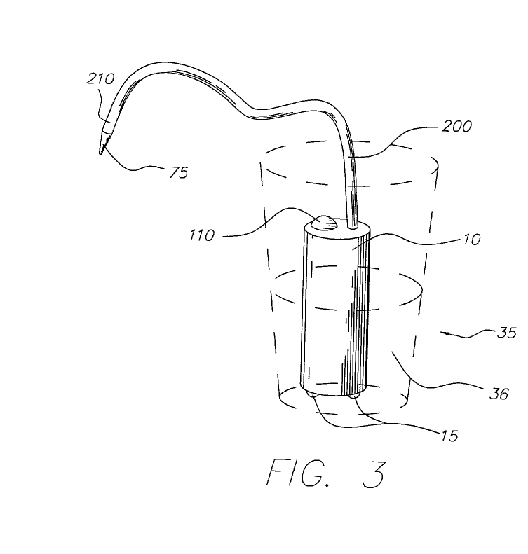

FIG. 3 depicts an isometric view of the immersion-type device, having Clearance Bumps 15, at the bottom of the Housing 10, which Clearance Bumps 15, facilitate the flow of cleaning fluid into Intake Channel 90. Furthermore, in this variation the Switch Cover 110, protecting the Switch 100, is at the top of said Housing 10. Finally, the Flexible Output Tube 200, terminates in a Nozzle 75, attached at the Free End 210, of said Flexible Output Tube 200.

Wherein, in operation, a user fills a Cleaning Fluid Container 35, such as a small drinking cup, with Cleaning Fluid 36, and immerses the device within said Cleaning Fluid Container 35. Whereas the Switch 100, is at the bottom of the Housing 10, the device will automatically operate, else the user will depress the Switch Cover 110, activating the device. Upon such activation, the Motor 20, rotates the Impeller 50, forcing the Cleaning Fluid 36, into the device through the Intake Channel 90, and expelling it through the Free End 210, of the Flexible Output Tube 200, or through the Nozzle 75, in the form of a powerful jet. The user, by manipulating the Free End 210, of the Flexible Output Tube 200, may then direct the stream of cleaning fluid thus generated, at locations of shaving residue accumulation in the razor, cleaning said razor.

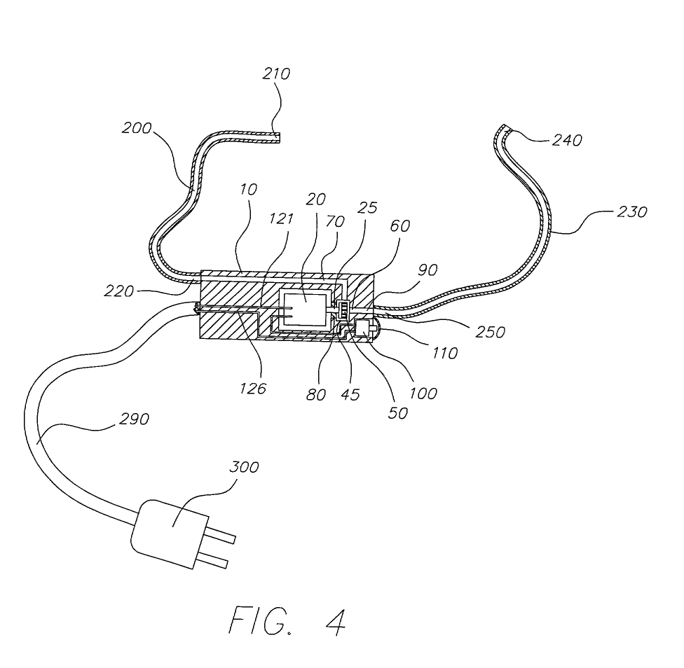

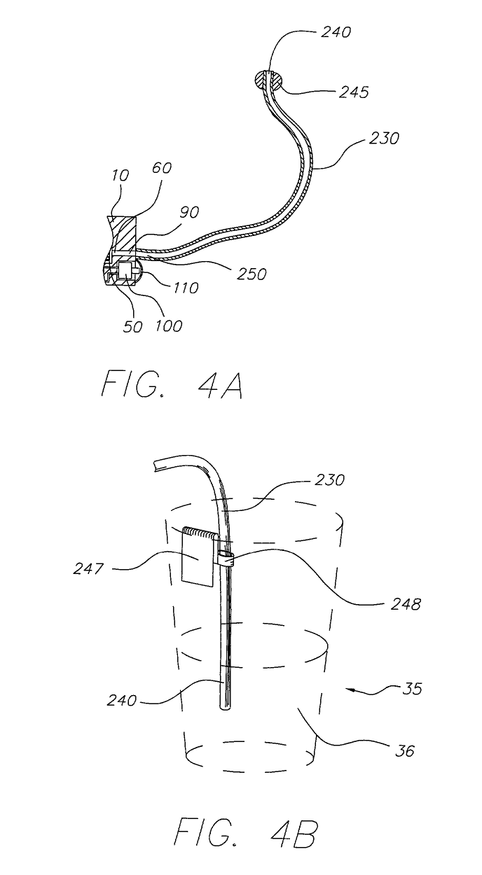

Other variations of the invention exist, such as depicted in FIG. 4. This variation is a countertop device, comprising a Housing 10, having a Motor 20, mechanically connected to an Impeller 50, residing in a Pump Cavity 45, via a Motor Shaft 25. A Pump Seal 80, around the Motor Shaft 25, keeps fluids from entering the Motor 20.

The Pump Cavity 45, has a Pump Intake Port 60, fluidly communicating with an Attached End 250, of a Flexible Intake Tube 230, via an Intake Channel 90, said Flexible Intake Tube 230, also having a Free End 240 open to the outside. Said Pump Cavity 45 furthermore has a Pump Output Port 70, fluidly communicating with a Flexible Output Tube 200, having an Attached End 220, attached to the Housing 10, and a Free End 210, open to the outside.

Said Motor 20, is electrically connected to an Electric Plug 300, via an Electric Cable 290, a Hot Wire 126, a Switch 100, and a Neutral Wire 121, whereby, when the Electric Plug 300 is plugged into a wall outlet, and the Switch 100, operated, electric current flows through the Motor 20.

A flexible Switch Cover 110, protects the Switch 100, from splashes of liquid and other debris.

In operation, a user fills a small container such as a drinking cup with cleaning fluid, and immerses the Free End 240, of said Flexible Intake Tube 230, within such cleaning fluid. Then the user plugs in the device and runs the Motor 20, by activating the Switch 100. The Motor 20, rotates the Impeller 50, which forms a self-priming pump within said Pump Cavity 45, and forces cleaning fluid into the Free End 240, of said Flexible Intake Tube 230, expelling it through the Free End 210, of said Flexible Output Tube 200, forming a powerful jet of cleaning fluid. The user, by manipulating the Free End 210, of said Flexible Output Tube 200, may then direct the stream of cleaning fluid thus generated, at locations of shaving residue accumulation in the razor, cleaning said razor.

FIG. 4A shows a variation of the device depicted in FIG. 4, wherein the Free End 240, of said Flexible Intake Tube 230, has a Weight 245, attached, wherein said Weight 245, ensures proper immersion of the Free End 240, of said Flexible Intake Tube 230, within the cleaning fluid.

FIG. 4B shows another example of securing the Flexible Intake Tube 230, to a Cleaning Fluid Container 35, and ensuring that the Free End 240, of said Flexible Intake Tube is immersed within the Cleaning Fluid 36. A Clip 247, having an attached Ring 248, is placed on the lip of said Cleaning Fluid Container 35, such that the Ring 248, hangs on the inside of said Cleaning Fluid Container 35. The Flexible Intake Tube 230, is threaded through said Ring 248, and the Free End 240, of the Flexible Intake Tube 230, is immersed in said Cleaning Fluid 36. Said Clip 247, with said attached Ring 248, could be an integral part of said Flexible Intake Tube 230, with the Clip 247, and its attached Ring 248, being slidably adjustable along said Flexible Intake Tube 230. Other methods of attachment, such as magnetic attachment of the Flexible Intake Tube 230, to the Cleaning Fluid Container 35, are also within the scope of the present specification.

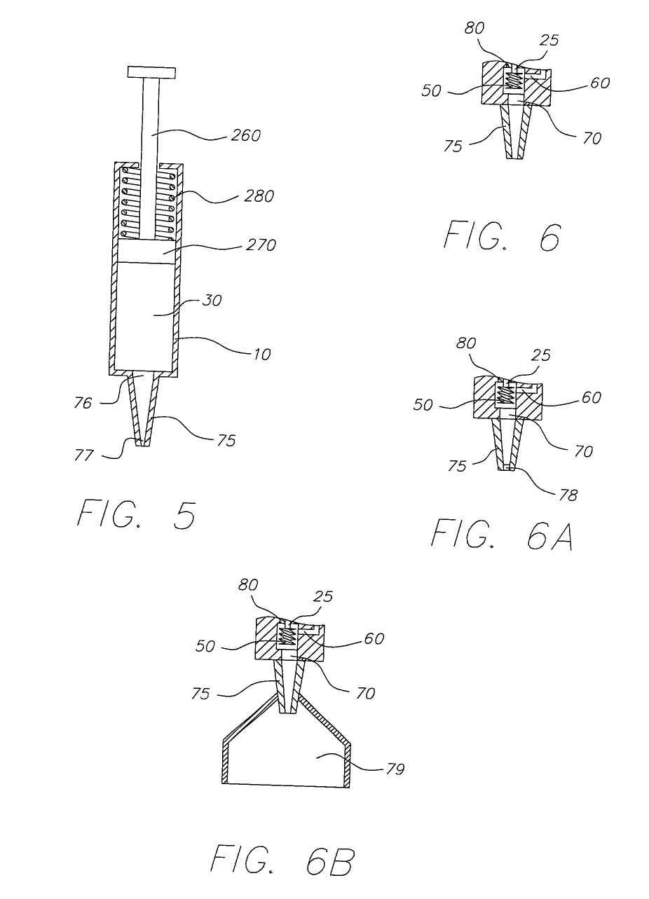

FIG. 5 depicts a manually operated embodiment of the invention, wherein a Housing 10, has a Holding Chamber 30, of generally cylindrical shape, wherein a Piston 270, attached to a Plunger 260, is moving freely. A Spring 280, is biasing the Piston 270, toward the front end of said Holding Chamber 30, said front end forming a Nozzle 75, having a Nozzle Input Aperture 76, and a Nozzle Output Aperture 77, open to the outside. In operation, a user immerses the nozzle in cleaning fluid and withdraws the Piston 270, by pulling back the Plunger 260. This action compresses the Spring 280, and fills the Holding Chamber 30, with cleaning fluid. The user subsequently releases the Plunger 260, and the Spring 280, forces the Piston 270, forward, expelling fluid in a powerful stream through the Nozzle Output Aperture 77. The user, by manipulating the entire device, may then direct the stream of cleaning fluid thus generated, at locations of shaving residue accumulation in the razor, cleaning said razor.

The nozzle design and/or use is not limited to the specific embodiments described thus far. By way of example, a Nozzle 75, could be attached to the Pump Output Port 70, of the self-contained device described in conjunction with FIG. 1. FIG. 6A depicts such an embodiment. FIG. 6B depicts a similar embodiment, wherein the Nozzle 75, has Roughened Interior Walls 78, advantageously inducing a turbulent flow, which more effectively cleans razors with the inherent sudden velocity variations within the turbulent stream of cleaning fluid. FIG. 6C depicts a Nozzle 75, having a Splash Guard 79, preferably of sufficient size to contain the entire razor head. Said Splash Guard 79, controls splashes of cleaning fluid as it is deflected by the razor, and may be rigid or flexible, permanently attached to the Nozzle 75, or removable, or having features to attach directly to Housing 10.

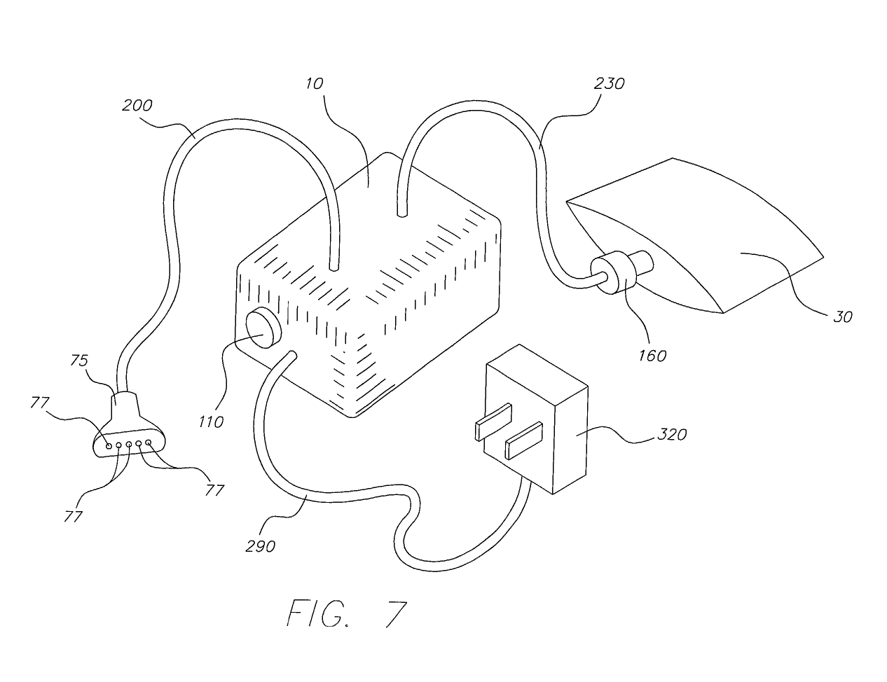

FIG. 7 is an isometric view of a countertop embodiment of the invention, wherein the Flexible Output Tube 200, terminates in a Nozzle 75, having multiple Nozzle Output Apertures 77. Furthermore, the Flexible Intake Tube 230, is connected to the Holding Chamber Cover 160, of a Holding Chamber 30, said Holding Chamber 30, advantageously having collapsible walls. Additionally, an Electric Cable 290, has Conditioning Electronics 320, attached to its end, wherein, in operation a user fills the Holding Chamber 30, with cleaning fluid, and attaches the Flexible Intake Tube 230, to said Holding Chamber 30, by means of the Holding Chamber Cover 160. Then the user depresses the Switch Cover 110, operating the device. The Conditioning Electronics 320, reduce the electric outlet voltage to a safe level, and may also perform an AC/DC conversion. Although the Conditioning Electronics 320, are depicted attached at the free end of the Electric Cable 290, they alternatively may reside within the Housing 10.

The collapsible walls of Holding Chamber 30, collapse as the cleaning fluid is removed from the Holding Chamber 30, thus eliminating the need for a vent valve for venting said Holding Chamber 30.

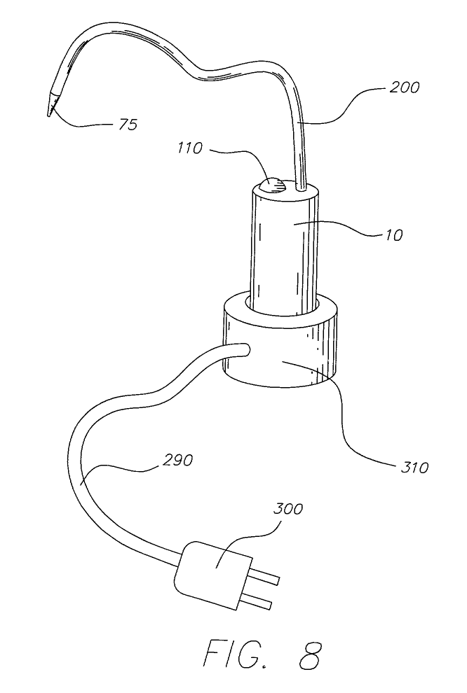

Yet another embodiment of the invention comprises rechargeable batteries enclosed within the Housing 10. For example, the device depicted in FIG. 8, may contain a rechargeable battery permanently installed within the Housing 10, or removable, a power coil, and conditioning electronics for charging the battery. A user would recharge the battery by placing the device within a Charging Base 310, having a matching power coil, and an Electric Cable 290, connected to an Electric Plug 300, and plugging the Electric Plug 300, into a wall outlet. The use of such methods for charging rechargeable batteries is well known in the art.

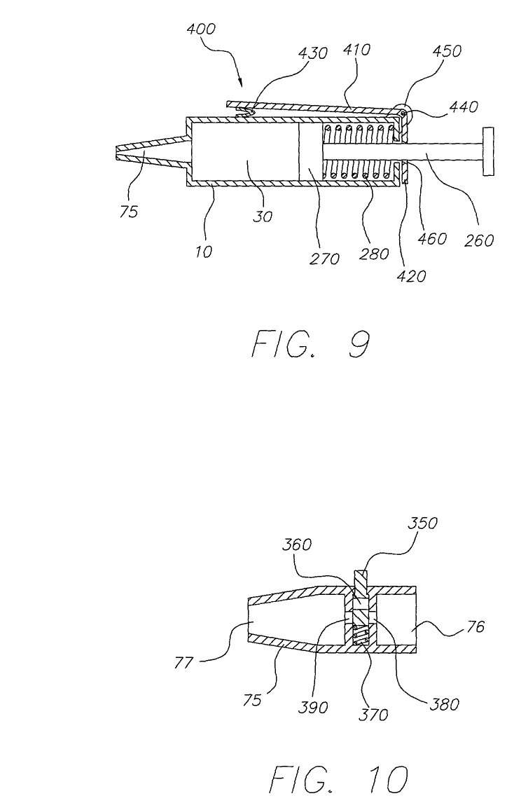

FIG. 9 is a cross-sectional view of a variation of the manually-operated embodiment shown in FIG. 5, wherein this variation has means for controllably releasing a stream of cleaning fluid. Said means comprise a Brake Mechanism 400, having a Brake Handle 410, rigidly attached to a Brake Plate 420, said Brake Plate 420, having an Opening 460. Said Brake Mechanism 400, pivots about a Pivot Pin 440, attached to a Brake Support Structure 450. Said Brake Support Structure 450, is rigidly attached to the Housing 10. A Brake Spring 430, is biasing the Brake Handle 410, in a clockwise direction with reference to FIG. 9, and away from the Housing 10. This action of the spring rotates the Brake Plate 420, thereby rotating the Opening 460, such that the internal walls of the Opening 460, interfere with the Plunger 260. When the user withdraws the Plunger 260, compressing the spring, the shape of the Opening 460, and its position relative to the Pivot Pin 440, force the Brake Mechanism 400, to rotate slightly counterclockwise and allow movement of the Plunger 260. Upon release of the Plunger 260, the frictional forces generated by the interference between the Plunger 260, and the internal walls of the Opening 460, further tend to rotate the Brake Mechanism 400, clockwise, increasing the interference, effectively locking the Plunger 260, and preventing its motion. To release the Plunger 260, and expel cleaning liquid from the Nozzle 75, the user slightly depresses the Brake Handle 410, removing the interference. Upon release of the Brake Handle 410, the Brake Spring 430, biases the Brake Mechanism 400, clockwise again, thereby stopping the plunger once more, stopping the ejection of cleaning fluid.

Whereas a specific brake mechanism is described herein, several other brake mechanisms and other methods of controlling the flow of cleaning fluid may be implemented and are within the scope of the present invention. By way of example, FIG. 10 depicts a cross-sectional view of a flow control valve located in the Nozzle 75, separating the Nozzle Input Aperture 76 from the Nozzle Output Aperture 77. The valve comprises walls having a Valve Input Aperture 380, and a Valve Output Aperture 390. Within the valve a Valve Actuator 350, having an Actuator Port 360, is allowed to move. An Actuator Spring 370, biases the Valve Actuator 350, such that the Actuator Port 360, the Valve Input Aperture 380, and the Valve Output Aperture 390, are misaligned, thereby preventing the flow of cleaning fluid through the valve. When the pressurizing means of the razor cleaning device is activated, a user depresses the Valve Actuator 350, thereby aligning the Actuator Port 360, the Valve Input Aperture 380 and the Valve Output Aperture 390, permitting the flow of cleaning fluid from the Nozzle Input Aperture 76 to the Nozzle Output Aperture 77. Upon release of the Valve Actuator 350, the Actuator Spring 370, biases the Valve Actuator 350, in a position of misalignment, thereby stopping the flow of cleaning fluid.

The valve described herein is commonly known in the art as a gate valve. Other types of valves may be used instead, such as a ball valve, a needle valve, a valve wherein a flexible tube gets pinched thereby controlling the flow of fluid, etc.

Whereas the invention has been described herein in terms of specific embodiments, persons skilled in the art will readily recognize that many more embodiments are possible and fall within the scope of this invention. For example, all combinations of all features of each embodiment with each other embodiment will result in a multitude of new embodiments which all fall within the scope of this invention. Furthermore, a variety of other features, may be added or substitute existing features in each embodiment. By way of example, pressurizing means may include a pressurized gas cylinder able to attach to the Housing 10, by means of quick disconnect valves, or a manual pump and a pressure chamber, in fluid communication with the Holding Chamber 30. In such embodiments means for controlling the gas pressure may be included. The flow valve may be placed within the Housing 10, instead of in the Nozzle 75. The electrical switch may be substituted by an optoelectronic switch, or Hall effect switch, or a Reed switch. The switch may be placed near the Free End 210, of the Flexible Output Tube 200. Alternatively, such embodiments may have no switch at all, operating the moment that are plugged into the wall, or the batteries installed, for example. Also, the rechargeable batteries may be recharged by photoelectric cells, attached to the Housing 10, or in a separate module that the device is plugged in after each use. Therefore, the scope of this invention should be determined in reference to the claims, herein.

What is claimed is:

1. A razor cleaning device comprising:
a body, having a cavity for holding cleaning fluid;
pressurizing means;
at least one maneuverable output aperture having at least one internal wall, whereby a high pressure side internal to the device fluidly communicates with a low pressure side external to the device;
said cavity, pressurizing means and output aperture fluidly communicating, wherein when said cavity contains cleaning fluid and said pressurizing means are operated, cleaning fluid is expelled through said output aperture, creating at least one high speed stream of cleaning fluid which, by manipulating said output aperture, may be directed at areas of shaving residue in razors at various angles of incidence, removing such residue.

2. The razor cleaning device as set forth in claim 1 wherein said output aperture is rigidly attached to said body.

3. The razor cleaning device as set forth in claim 1 further comprising a flexible tube having a first end connected to said body and a second end connected to said output aperture.

4. The razor cleaning device as set forth in claim 1 wherein the pressurizing means comprise:
a pump;
a motor connected to the pump;
Power supply means for supplying power to the motor.

5. The razor cleaning device as set forth in claim 4 wherein said power supply means comprise at least one battery and electrical circuitry.

6. The razor cleaning device as set forth in claim 4 wherein said cavity is formed by rigid walls.

7. The razor cleaning device as set forth in claim 4 wherein said cavity is formed by flexible walls and is collapsible.

8. The razor cleaning device as set forth in claim 4 further comprising a control valve fluidly communicating with said output aperture, cavity and pressurizing means, wherein a user controllably releases said stream of fluid by operating the control valve.

9. The razor cleaning device as set forth in claim 1 wherein the pressurizing means comprise a spring, plunger and piston, wherein the piston is able to move within said cavity, and by pulling on the plunger a user may store energy in the spring which may subsequently be applied to the cleaning fluid via the piston.

10. The razor cleaning device as set forth in claim 9 further comprising a control valve fluidly communicating with said output aperture, cavity and pressurizing means, wherein a user controllably releases said stream of fluid by operating the control valve.

11. The razor cleaning device as set forth in claim 9 further comprising braking means connected to the pressurizing means, wherein a user controllably releases said stream of fluid by operating said braking means.

12. A razor cleaning device comprising:
a pump having at least one intake port and at least one output port;
a motor connected to the pump;
power supply means connected to the motor;
a first flexible tube having a first end attached to the output port of said pump and a second, free, maneuverable end with at least one output aperture;
wherein when said intake port is immersed in cleaning fluid and the pump operated, cleaning fluid is expelled through said output aperture, creating at least one high speed stream of cleaning fluid which, by manipulating the end of said first tube having said output aperture, may be directed at areas of shaving residue at various angles of incidence, removing such residue.

13. The razor cleaning device as set forth in claim 12 wherein said power supply means comprise at least one battery and electrical circuitry.

14. The razor cleaning device as set forth in claim 13 further comprising a control valve fluidly communicating with said pump and flexible tubing, wherein a user controllably releases said stream of fluid by operating the control valve.

15. A razor cleaning device comprising:
a pump having at least one intake port and at least one output port;
a motor connected to the pump;
power supply means connected to the motor;
a first flexible tube having a first end attached to the input port of said pump and a second, free end with at least one intake aperture;
wherein when said free end of said first tube is immersed in cleaning fluid and the pump operated, cleaning fluid is pumped through said intake aperture and expelled through said output port, creating at least one high speed stream of cleaning fluid which, by manipulating said pump, may be directed at areas of shaving residue at various angles of incidence, removing such residue.

16. The razor cleaning device as set forth in claim 15 wherein said means for supplying power comprise at least one battery and electrical circuitry.

17. The razor cleaning device as set forth in claim 15 further comprising a control valve fluidly communicating with said pump and first tube, wherein a user controllably releases said stream of fluid by operating the control valve.

18. The razor cleaning device as set forth in claim 15 further comprising a second flexible tube having a first end attached to the output port of said pump and a second, free, maneuverable end with at least one output aperture, wherein when said free end of said first tube is immersed in cleaning fluid and the pump operated, cleaning fluid is expelled through said output aperture, creating at least one high speed stream of cleaning fluid which, by manipulating the end of said second tube having said output aperture, may be directed at areas of shaving residue at various angles of incidence, removing such residue.

19. The razor cleaning device as set forth in claim 18 wherein said means for supplying power comprise at least one battery and electrical circuitry.

20. The razor cleaning device as set forth in claim 18 further comprising a control valve fluidly communicating with said pump, first tube and second tube, wherein a user controllably releases said stream of fluid by operating the control valve.
